(19) United States
(12) Patent Application Publication
(10) Pub. No.: US 2026/0027905 A1
(43) Pub. Date: Jan. 29, 2026

(54) EXTENDED-RANGE HYBRID POWER SYSTEM AND CONTROL METHOD THEREFOR, AND CRANE

(71) Applicant: XUZHOU HEAVY MACHINERY CO., LTD., Jiangsu (CN)

(72) Inventors: Zenghai SHAN, Jiangsu (CN); Jianguo ZHAO, Jiangsu (CN); Jianli LIU, Jiangsu (CN); Wenqing WANG, Jiangsu (CN)

(73) Assignee: XUZHOU HEAVY MACHINERY CO., LTD., Jiangsu (CN)

(21) Appl. No.: 18/995,146

(22) PCT Filed: Dec. 22, 2022
(86) PCT No.: PCT/CN2022/140914

§ 371 Date: Jan. 16, 2025

(30) Foreign Application Priority Data
Jul. 27, 2022 (CN) 202210890414.0

(51) Int. Cl. B60L 1/00; B60L 50/61; B60L 53/10; B66C 23/00; B66C 23/38; B66C 23/42

(52) U.S. Cl. CPC B60L 1/003; B60L 50/61; B60L 53/10; B66C 23/38; B66C 23/42; B66C 23/54; B60L 2200/40; B60L 2260/26; B66C 2700/0371; B66C 2700/0378

(57) ABSTRACT

The invention discloses an extended-range hybrid power system and a control method therefor, and a crane, and belongs to the technical field of construction machinery. The extended-range hybrid power system comprises a power battery, an all-in-one controller, a first motor, a second motor and an engine, wherein the first motor is connected to a lower traveling mechanism; the engine is connected to the second motor, and the second motor is connected to an upper operating mechanism; the power battery, the first motor and the second motor are connected to the all-in-one motor, and the all-in-one motor is connected to an external power supply.

### TECHNICAL FIELD

The invention belongs to the technical field of construction machinery, and particularly relates to an extended-range hybrid power system and a control method therefor, and a crane.

### TECHNICAL BACKGROUND

With the continuous development of science and technology and constant global attention to environmental management, energy shortage and other problems, China lays more emphasis on energy consumption in the construction machinery industry, and the whole construction machinery industry is developing towards energy conservation, emission reduction and environmental protection.

At present, traditional truck cranes drive a chassis to travel and an upper body to operate by means of an engine, power demands in these two states are different, the power required for driving the chassis to travel is much higher than the power required for driving the upper body to operate, and the engine needs to operate according to the traveling state of the chassis. During operation of the upper body, because of the high engine power, the engine generally cannot operate within a high-efficiency range, leading to high gasoline consumption. The power difference will become obvious with the increase in the tonnage of cranes. Large-tonnage cranes often adopt a double-engine configuration, that is, an engine is configured on the chassis and an engine configured on the upper body to respectively satisfy the requirement for traveling power and the requirement for operating power, but the overall cost and weight will be increased accordingly. A large amount of harmful gas will be emitted during long-term operation of the engine, the economical efficiency is low, and noise generated during traveling and operation will exert an impact on drivers and surroundings.

To solve these problems, cranes using electric energy as a power source or plug-in hybrid cranes emerge on the market. However, due to the short battery life, the adaptability to road traveling and operation of the upper body of pure electric cranes is poor; a chassis engine of the plug-in hybrid cranes generally cannot operate within a high-efficiency range during operation of the upper body.

Existing cranes mainly include single-engine cranes and double-engine cranes. As shown in FIG. 1, a chassis engine of the single-engine cranes not only provides power for traveling of the chassis, but also drives an oil pump by means of a clutch, a gearbox and a power takeoff to provide power for an upper hydraulic system during operation of the upper body. As shown in FIG. 2, a chassis engine and an upper engine of the double-engine cranes respectively provide power for traveling of the chassis and operation of the upper body.

The single-engine cranes have the following drawbacks: (1) the power demand in the traveling condition is drastically different from the power demand in the operating condition, and one power system cannot make a balance between these two power demands, and gasoline consumption during operation of the upper body is high; (2) during operation of the upper body, the engine operates within a low-speed and low-load range for a long time, so the exhaust gas temperature is low, carbon deposition occurs easily, and emission control calibration is complex; (3) during operation of the upper body, an air compressor, a steering pump, an air-conditioner compressor, and other attachments are in a no-load operating state, leading to a waste of energy. The double-engine cranes have the following drawbacks: (1) the structural arrangement of the double-engine cranes is difficult, and the space occupied by the double-engine cranes is large; (2) the maintenance cost of two engines is high.

### SUMMARY OF THE INVENTION

The objective of the invention is to overcome the defects in the prior art by providing an extended-range hybrid power system and a control method therefor, and a crane. One of a plug-in operating mode, a pure electric operating mode, a pure gasoline operating mode and a hybrid operating mode may be selected for operation of an upper body, and a pure electric traveling mode or an extended-range traveling mode may be selected for traveling of a lower body, such that the working efficiency of an engine is improved, gasoline consumption and exhaust emission are reduced, and the environmental friendliness is good.

The invention provides the following technical solution:
In a first aspect, the invention provides an extended-range hybrid power system, comprising a power battery, an all-in-one controller, a first motor, a second motor and an engine, wherein:
the first motor is connected to a lower traveling mechanism;
the engine is connected to the second motor, and the second motor is connected to an upper operating mechanism;
the power battery, the first motor and the second motor are connected to the all-in-one controller,
and the all-in-one controller is connected to an external power supply.

Further, the lower traveling mechanism comprises a gearbox connected to the first motor, a transmission shaft connected to the gearbox, and a drive axle connected to the transmission shaft.

Further, the engine is arranged on an upper body and connected to a first clutch, the first clutch is connected to the second motor, the second motor is connected to a second clutch, and the second clutch is connected to the upper operating mechanism.

Further, the upper operating mechanism comprises a hydraulic pump, and a revolving device, a luffing device, a hoisting device, a telescopic boom and chassis outriggers which are driven by the hydraulic pump.

Further, the all-in-one controller is connected to the power battery by means of a BMS and connected to the first motor by means of a first MCU.

Further, the all-in-one controller is connected to a central revolving device, and the central revolving device is connected to the second motor by means of a second MCU.

In a second aspect, the invention provides a control method for the extended-range hybrid power system in the first aspect, wherein operating modes for operation of an upper body comprise a plug-in operating mode, a pure electric operating mode, a pure gasoline operating mode and a hybrid operating mode; and traveling modes for traveling of a lower body comprise a pure electric traveling mode and an extended-range traveling mode.

Further, as for the operation of the upper body:
in the presence of an external power supply, the upper body automatically enters the plug-in operating mode, the engine is disconnected from the second motor, the second motor is connected to the upper operating mechanism, the external power supply enables the second motor to drive the upper operating mechanism to work by means of the all-in-one controller, and at the same time, the external power supply charges the power battery by means of the all-in-one controller;
when a state of charge of the power battery is sufficient and higher than a design threshold A, users select the pure electric operating mode, the engine is disconnected from the second motor, the second motor is connected to the upper operating mechanism, the power battery enables the second motor to drive the upper operating mechanism to work by means of the all-in-one controller, and when the state of charge of the power battery is lower than design threshold A, the users will be reminded to exit from the pure electric operating mode;
when the users select the pure gasoline operating mode, the engine is connected to the second motor, the second motor is connected to the upper operating mechanism, the engine drives the upper operating mechanism to work by means of a rotor of the second motor, and when the state of charge of the power battery is low, the second motor functions as a generator to charge the power battery;
when the users select the hybrid operating mode, the engine is connected to the second motor, the second motor is connected to the upper operating mode, the engine drives the upper operating mechanism to work by means of the rotor of the second motor, and according to a load condition during operation of the upper body, efficiency of the engine and the state of charge of the power battery, the second motor operates timely to adjust a torque output of the engine to ensure that the engine operates within a high-efficiency and economical range.

Further, as for the traveling of the lower body:
when a state of charge of the power battery is sufficient and higher than a design threshold A, users select the pure electric traveling mode, the power battery enables the first motor to drive the lower traveling mechanism to work by means of the all-in-one controller to realize traveling of a vehicle, and when the state of charge of the power battery is lower than the design threshold A, the users will be reminded to exit from the pure electric operating mode;
when the users select the extended-range traveling mode, if the state of charge of the power battery is sufficient and higher than the design threshold A, the power battery enables the first motor to drive the lower traveling mechanism to work by means of the all-in-one controller to realize traveling of the vehicle; when the state of charge of the power battery is lower than the design threshold A, the engine is connected to the second motor, the second motor is disconnected from the upper operating mechanism, and the engine is started to drive the second motor to generate power to charge the power battery by means of the all-in-one controller and at the same time, to enable the first motor to drive the lower traveling mechanism to work by means of the all-in-one controller to realize traveling of the vehicle; when the state of charge of the power battery is higher than a design threshold B, the engine stops, the power battery enables the first motor to drive the lower traveling mechanism to work by means of the all-in-one controller to realize traveling of the vehicle until the state of charge of the power battery is lower than the design threshold A, at this moment, the engine is started again, and the process is repeated; and when the state of charge of the power battery is between the threshold A and the threshold B, the engine generates power timely according to a power demand for traveling of the lower body to prevent power of the power battery form being consumed too fast.

In a third aspect, the invention provides a crane, comprising the extended-range hybrid power system in the first aspect and using the control method in the second aspect to implement operation of an upper body and traveling of a lower body.

Compared with the prior art, the invention has the following beneficial effects:
(1) The pure electric traveling mode and the extended-range traveling mode are provided for traveling of a lower body; in the pure electric traveling mode, no gasoline is consumed; in the extended-range traveling mode, the engine neither needs to directly drive a vehicle to travel nor needs to change the output power according to the power demand for traveling, so the engine generates power within a high-efficiency and economical range, and the engine displacement and power are lower than the engine displacement and power of traditional gasoline vehicles, such that gasoline consumption and exhaust emission in the traveling process are reduced, energy is saved, and emission is reduced; in addition, because motor driving is adopted in the traveling process of the vehicle, the acceleration performance of the vehicle is good, noise of the vehicle is low, and driving comfort is better;
(2) The plug-in operating mode, the pure electric operating mode, the pure gasoline operating mode and the hybrid operating mode are provided for operation of an upper body, wherein in the plug-in operating mode and the pure electric operating mode, no gasoline is consumed; in the pure electric operating mode, the engine directly drives the upper body to operate, such that the situation that the upper body cannot work due to a fault of a high-voltage system is avoided, and the adaptability of a crane is improved; in the hybrid operating mode, an engine and a motor work at the same time, such that the torque is large, the working efficiency is high, and the motor can adjust the torque of the engine, thus improving the working efficiency of the engine and reduce gasoline consumption.

### DESCRIPTION OF THE DRAWINGS

FIG. 1 illustrates an operating mode of a single-engine crane mentioned in the background art of the invention;

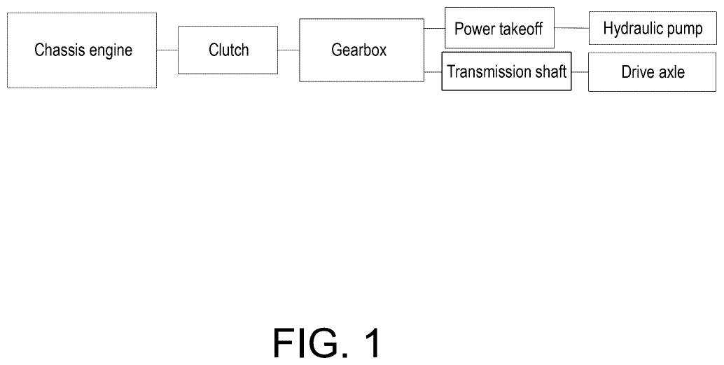

FIG. 2 illustrates an operating mode of a double-engine crane mentioned in the background art of the invention;

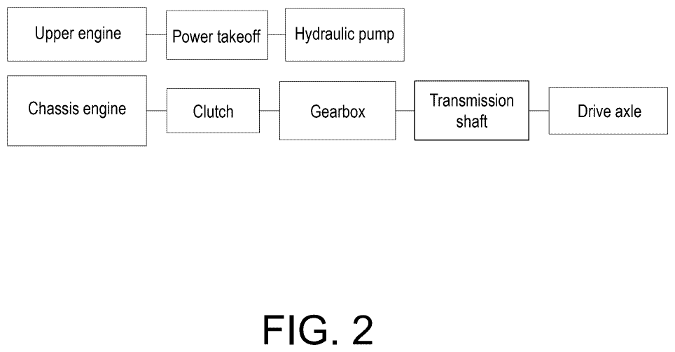

FIG. 3 is a schematic diagram of an extended-range hybrid power system according to one embodiment of the invention.

### DETAILED DESCRIPTION OF THE EMBODIMENTS

The invention is further described below in conjunction with accompanying drawings. The following embodiments are merely used to more clearly explain the technical solutions of the invention and should not be construed as limiting the protection scope of the invention.

### Embodiment 1

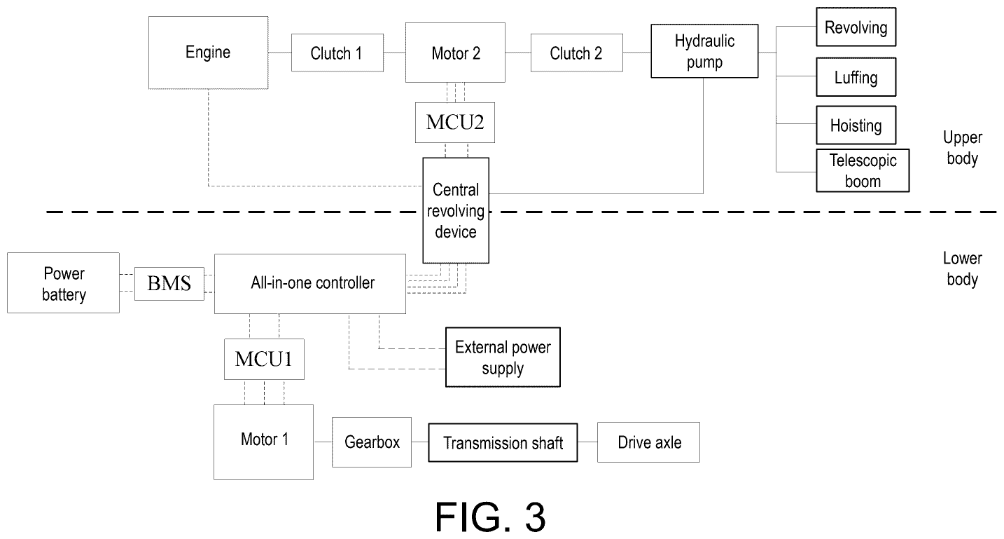

As shown in FIG. 3, this embodiment provides an extended-range hybrid power system, comprising a power battery, an all-in-one controller, a motor 1, a motor 2 and an engine.

The power battery is arranged on a lower body and connected to the all-in-one controller by means of a BMS, the all-in-one controller is connected to a central revolving device, the central revolving device is connected to the motor 2 by means of an MCU2, and high-voltage power of the power battery is transmitted to the motor 2 by means of the BMS, the all-in-one controller, the central revolving device and the MCU2. The all-in-one controller is connected to the motor 1 by means of an MCU1, and the motor 1 is connected to a lower traveling mechanism; the lower traveling mechanism comprises a gearbox connected to the motor 1, a transmission shaft connected to the gearbox, and a drive axle connected to the transmission shaft. High-voltage power of the power battery is transmitted to the motor 1 by means of the BMS, the all-in-one controller and the MCU1, and the motor 1 is connected to the drive axle by means of the gearbox and the transmission shaft to drive the lower body to travel.

The engine is arranged on an upper body and connected to a clutch 1, the clutch 1 is connected to an input shaft of the motor 2, an output shaft of the motor 2 is connected to a clutch 2, and the clutch 2 is connected to an upper operating mechanism. The upper operating mechanism comprises a hydraulic pump connected to the clutch 2, and a revolving device, a luffing device, a hoisting device, a telescopic boom and chassis outriggers which are driven by the hydraulic pump. The hydraulic pump is driven by the motor 2, or is driven by the engine by means of the clutch 1 and a rotor of the motor 2, or is driven by the motor 2 and the engine. The hydraulic pump drives an upper hydraulic system to implement revolving, luffing, hoisting, telescoping or other operations, and the hydraulic pump is connected to the central revolving device and can transfer hydraulic oil to complete operations of the outriggers on the lower body.

The all-in-one controller is also connected to an external power supply to realize a plug-in operating mode.

In this embodiment, the engine, the motor 1, the motor 2 and the power battery are connected to the all-in-one controller by means of the MCUs or the BMS, and the central revolving device transfers hydraulic signals, high-voltage power and communication signals from the upper body and the lower body. High-voltage power transmission between the upper body and the lower body is realized by a high-voltage slip ring.

In this embodiment, the engine arranged on the upper body can extend the traveling range of the lower body and can also drive the upper body to operate, and the engine on the upper body is connected to the hydraulic pump by means of the clutches and the motor 2, such that parallel connection of the engine and the motor is realized.

In this embodiment, the power battery, the BMS and the all-in-one controller are arranged on the lower body. In other embodiments, the power battery, the BMS and the all-in-one controller may be arranged on the upper body.

In other embodiments, the clutch 2 may be omitted, and when the engine drives the motor 2 to generate power to extend the range of the lower body, the hydraulic pump on the upper body operates normally.

In other embodiments, any one or more of revolving, luffing and hoisting may be implemented based on motor driving.

### Embodiment 2

As shown in FIG. 3, this embodiment provides a control method for the extended-range hybrid power system according to Embodiment 1, wherein operating modes for operation of an upper body comprise a plug-in operating mode, a pure electric operating mode, a pure gasoline operating mode and a hybrid operating mode; and traveling modes for traveling of a lower body comprise a pure electric traveling mode and an extended-range traveling mode.

(1) Operation of the upper body:
in the presence of an external power supply, the upper body automatically enters the plug-in operating mode, the clutch 1 between the engine and the motor 2 is disengaged, the clutch 2 between the motor 2 and the hydraulic pump is engaged, the external power supply transmits high-voltage power to the MCU2 by means of the all-in-one controller and the central revolving device, the motor 2 is controlled by the MCU2 to directly drive the hydraulic pump to work to implement revolving, luffing, telescoping and hoisting of the upper body and actions of the chassis outriggers, and the engine flames out. Meanwhile, the external power supply charges the power battery by means of the all-in-one controller and the BMS.

When the state of charge of the power battery is sufficient and higher than a design threshold A (such as 30%), users may select the pure electric operating mode; similar to the plug-in operating mode, the clutch 1 between the engine and the motor 2 is disengaged, the clutch 2 between the motor 2 and the hydraulic pump is engaged, the power battery drives the motor 2 by means of the BMS, the all-in-one controller, the central revolving device and the MUC2, the motor 2 drives the hydraulic pump to implement revolving, luffing, telescoping and hoisting of the upper body and the actions of the chassis outriggers. When the state of charge of the power battery is lower than the design threshold A, the users are reminded to exit from the pure electric operating mode.

When the users select the pure gasoline operating mode, the clutch 1 between the engine and the motor 2 is engaged, the clutch 2 between the motor 2 and the hydraulic pump is engaged, the engine drives the hydraulic pump to work by means of the clutch 1, the rotor of the motor 2 and the clutch 2 to implement revolving, luffing, telescoping and hoisting of the upper body and the actions of the chassis outriggers. In this mode, the motor 2 does not output power, and when the state of charge of the power battery is lower than a threshold C, the motor 2 may function as a generator to charge the power battery.

When the users select the hybrid operating mode, the clutch 1 between the engine and the motor 2 is engaged, the clutch 2 between the motor 2 and the hydraulic pump is engaged, and the engine drives the hydraulic pump to work by means of the clutch 1, the rotor of the motor 2 and the clutch 2. In this process, according to the load condition of the upper body, the efficiency of the engine and the state of charge of the power battery, the motor 2 operates timely to adjust a torque output of the engine to ensure that the engine operates within a high-efficiency and economical range to reduce gasoline consumption and exhaust emission.

(2) Traveling of the lower body:
when the state of charge of the power battery is sufficient and higher than the design threshold A, users may select the pure electric traveling mode, the power battery drives the motor 1 by means of the BMS, the all-in-one controller and the MUC1, and the motor 1 drives a whole vehicle to travel by means of the gearbox, the transmission shaft and the axle. When the state of charge of the power battery is lower than the design threshold A, the users will be reminded to perform mode switching.

When the users select the extended-range traveling mode, if the state of charge of the power battery is sufficient and higher than the design threshold A, similar to the pure electric traveling mode, the power battery drives the motor 1 by means of the BMS, the all-in-one controller and the MUC1, and the motor 1 drives the whole vehicle to travel by means of the gearbox, the transmission shaft and the axle. When the state of charge of the power battery is lower than the design threshold A, the clutch 1 between the engine and the motor 2 is engaged, the clutch 2 between the motor 2 and the hydraulic pump is disengaged, and the engine is started to drive the motor 2 to generate power to charge the power battery by means of the MCU2, the central revolving device, the all-in-one controller and the BMS, and at the same time, to drive the motor 1 by means of the MCU2, the central revolving device, the all-in-one controller and the MCU1 so as to drive the vehicle to travel; when the state of charge of the power battery is higher than a threshold B, the engine stops, and the power battery drives the vehicle to travel by means of the motor 1 until the state of charge of the power battery is lower than the design threshold A, at this moment, the engine is started again, and this process is repeated; and when the state of charge of the power battery is between the threshold A and the threshold B, the engine will generate power timely according to the power demand for traveling of the lower body to prevent power of the power battery from being consumed too fast.

As for the threshold A and the threshold B mentioned above, for example, the threshold A is 30%, and the threshold B is 90%. When the state of charge of the power battery is lower than 30%, users will be reminded to exit from the pure electric modes, and the engine starts to generate power; when the state of charge of the power battery is higher than 90%, the engine stops generating power.

### Embodiment 3

This embodiment provides a crane, which is provided with the extended-range hybrid power system according to Embodiment 1 and adopts the control method according to Embodiment 2 to realize operation of an upper body and traveling of a lower body. During operation of the upper body, a motor may be used to drive an upper hydraulic system to operate, or an engine may be used to drive the upper hydraulic system to operate, or the engine and the motor may work together to drive the upper body to operate. During traveling of the lower body, a motor is used to realize pure electric traveling of the lower body, and in the traveling process, the engine can generate power for traveling of the lower body. Compared with traditional chassis engines, the engine on the upper body is lower in power, thus reducing gasoline consumption and carbon emission of a vehicle and being cleaner.

The above embodiments are merely preferred ones of the invention. It should be noted that those ordinarily skilled in the art can make some improvements and transformations without departing from the technical principle of the invention, and all these improvements and transformations should also fall within the protection scope of the invention.

1. An extended-range hybrid power system, comprising a power battery, an all-in-one controller, a first motor, a second motor and an engine;
the first motor is connected to a lower traveling mechanism;
the engine is connected to the second motor, and the second motor is connected to an upper operating mechanism; and
the power battery, the first motor and the second motor are connected to the all-in-one controller, and the all-in-one controller is connected to an external power supply.

2. The extended-range hybrid power system according to claim 1, wherein the lower traveling mechanism comprises a gearbox connected to the first motor, a transmission shaft connected to the gearbox, and a drive axle connected to the transmission shaft.

3. The extended-range hybrid power system according to claim 1, wherein the engine is arranged on an upper body and connected to a first clutch, the first clutch is connected to the second motor, the second motor is connected to a second clutch, and the second clutch is connected to the upper operating mechanism.

4. The extended-range hybrid power system according to claim 1, wherein the upper operating mechanism comprises a hydraulic pump, and a revolving device, a luffing device, a hoisting device, a telescopic boom and chassis outriggers which are driven by the hydraulic pump.

5. The extended-range hybrid power system according to claim 1, wherein the all-in-one controller is connected to the power battery by means of a BMS and connected to the first motor by means of a first MCU.

6. The extended-range hybrid power system according to claim 1, wherein the all-in-one controller is connected to a central revolving device, and the central revolving device is connected to the second motor by means of a second MCU.

7. A control method for the extended-range hybrid power system according to claim 1, wherein operating modes for an operation of an upper body comprise a plug-in operating mode, a pure electric operating mode, a pure gasoline operating mode and a hybrid operating mode; and traveling modes for traveling of a lower body comprise a pure electric traveling mode and an extended-range traveling mode.

8. The control method for the extended-range hybrid power system according to claim 7, wherein as for the operation of the upper body:
in the presence of the external power supply, the upper body automatically enters the plug-in operating mode, the engine is disconnected from the second motor, the second motor is connected to the upper operating mechanism, the external power supply enables the second motor to drive the upper operating mechanism to work by means of the all-in-one controller, and at the same time, the external power supply charges the power battery by means of the all-in-one controller;
when a state of charge of the power battery is sufficient and higher than a design threshold A, users select the pure electric operating mode, the engine is disconnected from the second motor, the second motor is connected to the upper operating mechanism, the power battery enables the second motor to drive the upper operating mechanism to work by means of the all-in-one controller, and when the state of charge of the power battery is lower than the design threshold A, the users will be reminded to exit from the pure electric operating mode;
when the users select the pure gasoline operating mode, the engine is connected to the second motor, the second motor is connected to the upper operating mechanism, the engine drives the upper operating mechanism to work by means of a rotor of the second motor, and when the state of charge of the power battery is low, the second motor functions as a generator to charge the power battery;
when the users select the hybrid operating mode, the engine is connected to the second motor, the second motor is connected to the upper operating mechanism, the engine drives the upper operating mechanism to work by means of the rotor of the second motor, and according to a load condition during operation of the upper body, efficiency of the engine and the state of charge of the power battery, the second motor operates timely to adjust a torque output of the engine to ensure that the engine operates within a high-efficiency and economical range.

9. The control method for the extended-range hybrid power system according to claim 7, wherein as for the traveling of the lower body:
when a state of charge of the power battery is sufficient and higher than a design threshold A, users select the pure electric traveling mode, the power battery enables the first motor to drive the lower traveling mechanism to work by means of the all-in-one controller to realize traveling of a vehicle, and when the state of charge of the power battery is lower than the design threshold A, the users will be reminded to exit from the pure electric operating mode;
when the users select the extended-range traveling mode, if the state of charge of the power battery is sufficient and higher than the design threshold A, the power battery enables the first motor to drive the lower traveling mechanism to work by means of the all-in-one controller to realize traveling of the vehicle; when the state of charge of the power battery is lower than the design threshold A, the engine is connected to the second motor, the second motor is disconnected from the upper operating mechanism, and the engine is started to drive the second motor to generate power to charge the power battery by means of the all-in-one controller and at the same time, to enable the first motor to drive the lower traveling mechanism to work by means of the all-in-one controller to realize traveling of the vehicle; when the state of charge of the power battery is higher than a design threshold B, the engine stops, the power battery enables the first motor to drive the lower traveling mechanism to work by means of the all-in-one controller to realize traveling of the vehicle until the state of charge of the power battery is lower than the design threshold A, at this moment, the engine is started again, and the process is repeated; and when the state of charge of the power battery is between the threshold A and the threshold B, the engine generates power timely according to a power demand for traveling of the lower body to prevent power of the power battery form being consumed too fast.

10. A crane, comprising An extended-range hybrid power system, comprising a power battery, an all-in-one controller, a first motor, a second motor and an engine, the first motor is connected to a lower traveling mechanism; the engine is connected to the second motor, and the second motor is connected to an upper operating mechanism; the power battery, the first motor and the second motor are connected to the all-in-one controller, and the all-in-one controller is connected to an external power supply, and the extended-range hybrid power system uses the control method according to claim 7 to implement operation of the upper body and traveling of the lower body.

11. A crane, comprising An extended-range hybrid power system, comprising a power battery, an all-in-one controller, a first motor, a second motor and an engine, the first motor is connected to a lower traveling mechanism; the engine is connected to the second motor, and the second motor is connected to an upper operating mechanism; the power battery, the first motor and the second motor are connected to the all-in-one controller, and the all-in-one controller is connected to an external power supply, and the extended-range hybrid power system uses the control method according to claim 8 to implement operation of the upper body and traveling of the lower body.

12. A crane, comprising An extended-range hybrid power system, comprising a power battery, an all-in-one controller, a first motor, a second motor and an engine, the first motor is connected to a lower traveling mechanism; the engine is connected to the second motor, and the second motor is connected to an upper operating mechanism; the power battery, the first motor and the second motor are connected to the all-in-one controller, and the all-in-one controller is connected to an external power supply, and the extended-range hybrid power system uses the control method according to claim 9 to implement operation of the upper body and traveling of the lower body.
